(19) United States
(12) Patent Application Publication
(10) Pub. No.: US 2005/0034585 A1
(43) Pub. Date: Feb. 17, 2005

(54) Shearing device for cutting assemblies

(76) Inventor: Keith E. Antal, Valatie, NY (US)

Correspondence Address: Thomas J. Durling;DRINKER BIDDLE & REATH LLP, One Logan Square, 18th & Cherry Streets, Philadelphia, PA, 19103-6996, US

(21) Appl. No.: 10/641,958

(22) Filed: Aug. 15, 2003

(51) Int. Cl. B26D 7/00

(52) U.S. Cl. 83/649

(57) ABSTRACT

A shearing device is adapted for use in combination with a cutting assembly. The shearing device is, furthermore, adapted for traversing within a cutting assembly guide which functions to facilitate sliding motion therein in a desired cutting direction, while delimiting motion/displacement in directions orthogonal to the cutting direction. The shearing device includes at least one pair of cutting blades wherein each of the cutting blades defines a least one edge inclined relative to the cutting direction. Furthermore, the blades are juxtaposed such that the inclined edges spatially converge to define a throat region and a convergence point. To maintain the spatial position of the cutting blades, a connecting means between the cutting blades. Further, a bearing support structure is disposed in combination with at least one of the cutting blades and engages the guide of the cutting assembly. Moreover, a handle is disposed in combination with at least one of the cutting blades and is adapted for traversing the cutting blades in the cutting assembly guide.

### TECHNICAL FIELD

The present invention relates to devices for cutting sheet material, and more particularly to a new and useful shearing device adapted for use in combination with guided cutting assemblies which enhances safety, facilitates low cost manufacture, produces a clean, even and reliable cut, while maintaining a low profile geometry for integration with a dispensing container.

### BACKGROUND OF THE INVENTION

Various cutting devices and assemblies are employed for cutting strips or sheets of web material from a dispensing container. Most familiar and frequently used are cutting assemblies for dispensing household products such as plastic wraps, metal foils and waxed papers, etc. Typically these products are disposed/sold in an elongate box and cut by means of a serrated cutter along an edge of the box to cut/separate the material into desired lengths for use. To dispense the material, the consumer holds an end of the material in one hand and the box dispenser in the other, pulls the two apart applying tension to the material, and rotates or otherwise orients the box so as to cause the serrated cutter to grab and cut the material. While box dispensers which employ serrated cutters of this type have and are still widely used for dispensing such materials, most consumers are familiar with (and tolerate) the various drawbacks and difficulties of such dispensing devices. For example, the application of tension and inefficiency of the serrated cutter may cause recoil or spring-back of the material (upon itself) requiring cumbersome separation/straightening of the material (into a flat sheet). The tendency for the material to spring back and fold upon itself may be even more problematic in materials having resilient properties (i.e. a low elastic modulus) such as plastic wraps.

Other difficulties relate to the inability for such serrated cutters to produce a clean, even cut, i.e., parallel to the axis of the webbed material. It will be appreciated that the serrated blades, which essentially puncture the material to create aligned perforations, produce a rough or tattered edge. While shaper blades produce a cleaner cut, such blades may be hazardous inasmuch as the blades are typically mounted to an edge of the container and are exposed.

Other cutting devices employ blades attached to and slideable within a guide track. The web material is dispensed, laid across the track, and cut by passing the cutting blade edgewise through the material. While these cutting devices produce a clean, even cut, the track and cutting blade typically protrude well beyond the exterior of the dispensing container thereby producing an unstreamlined external geometry. Aside from aesthetic drawbacks, the cutting device produces difficulties storing, packaging and stacking the dispensing containers. Further, inasmuch as the web material may not be tensioned during the cutting operation, the cutting blades employed are often highly sharpened to produce a clean cut. Such blades are most practically and conventionally formed by a metal alloy material which can be hardened (carburized) along the blade edge to improve the efficacy and durability of the blade. Drawbacks, however, to the use of metal cutting blades relate to the comparatively high fabrication costs relative to other potential material substitutes e.g., thermoplastics, which may be shaped utilizing lower cost manufacturing methods, e.g., casting, molding etc. Of course, material properties which are advantageous for the purpose of forming/shaping a material are typically dichotomous to properties which improve the yield strength and durability of a material. Consequently, the cutting blades for use in these applications are typically composed of metal and higher fabrication costs are accepted to achieve the desired hardness.

A need, therefore, exists for a cutting device which provides enhances operator safety, facilitates low cost manufacture, produces a clean even and reliable cut, while maintaining a low profile geometry for integration with a dispensing container.

### SUMMARY OF THE INVENTION

A shearing device adapted for use within a cutting assembly operative to guide and delimit the motion/displacement of the shearing blade as the shearing device traverses in a desired cutting direction. The shearing device includes at least one pair of cutting blades wherein each of the cutting blades defines a least one edge which is inclined relative to the cutting direction. Furthermore, the blades are juxtaposed such that the inclined edges spatially converge to define a throat region and a convergence point. To maintain the spatial position of the cutting blades, a connecting means is disposed between the cutting blades. Further, a bearing support structure is disposed in combination with at least one of the cutting blades and engages the guide of the cutting assembly. Moreover, a handle is disposed in combination with at least one of the cutting blades and is adapted for traversing the cutting blades in the cutting assembly guide.

### BRIEF DESCRIPTION OF THE DRAWINGS

For the purpose of illustrating the invention, there is shown in the drawings various forms that are presently preferred; it being understood, however, that this invention is not limited to the precise arrangements and constructions particularly shown.

FIG. 1 is a perspective view of a dispensing container having a elongate guide formed therein and a shearing device according to the present invention adapted for traversing within the guide.

FIG. 2a is a broken away cross sectional view taken substantially along line 2a-2a of FIG. 1 depicting the shearing device in combination with the guide.

FIG. 2b is a cross sectional view taken substantially along line 2b-2b of FIG. 2a.

FIG. 3a is an isolated plan view of the shearing device including a pair of cutting blades in juxtaposed relation and having edges which, in combination, converge to define a substantially V-shaped geometric profile.

FIG. 3b is a cross sectional view taken substantially along line 3b-3b of FIG. 3a.

FIG. 3c is an isolated view of a preferred embodiment of the shearing device wherein the blades are integrally formed and fold about a hinge to juxtaposition the cutting blades.

FIG. 3d is a cross sectional view taken substantially along line 3d-3d of FIG. 3c.

FIG. 4 is a schematic view of the inventive shearing device effecting an edgewise cut through a material to illustrate the advantageous shearing action of the present invention.

### DETAILED DESCRIPTION OF THE INVENTION

A shearing device is described for use in combination with a guided cutting assembly. Cutting assemblies of the type described are useful for dispensing a web of material, or sheet material from rolled material stock and cutting the web material to a desired length.

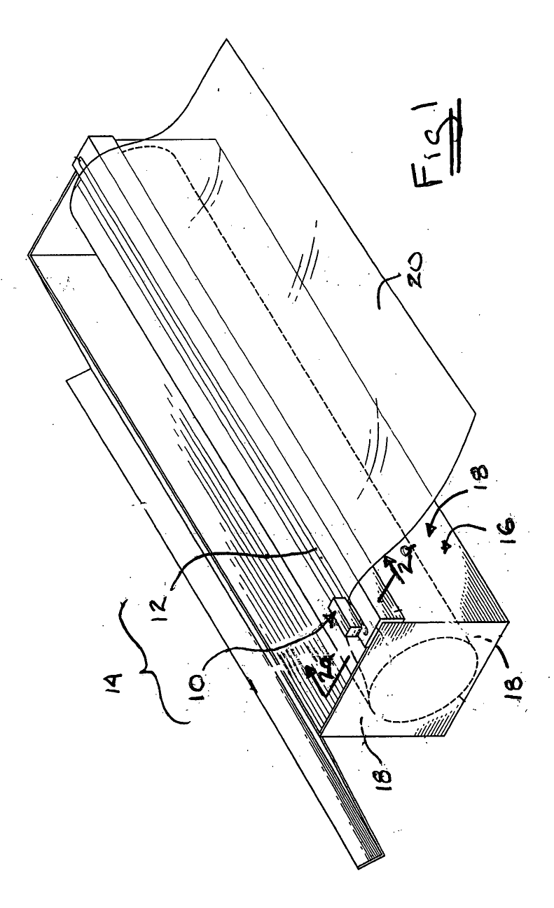

Referring now to the figures wherein reference numerals identify like elements, components, subassemblies etc., of the invention, FIG. 1 depicts a perspective view of an exemplary embodiment of the inventive shearing device 10. Specifically, the shearing device 10 is adapted for traversing within an elongate guide 12, which, as a unit, define a cutting assembly 14. The cutting assembly 14 is disposed in combination with a container 16 having a plurality of sidewalls 18 for dispensing sheets of webbed material 20.

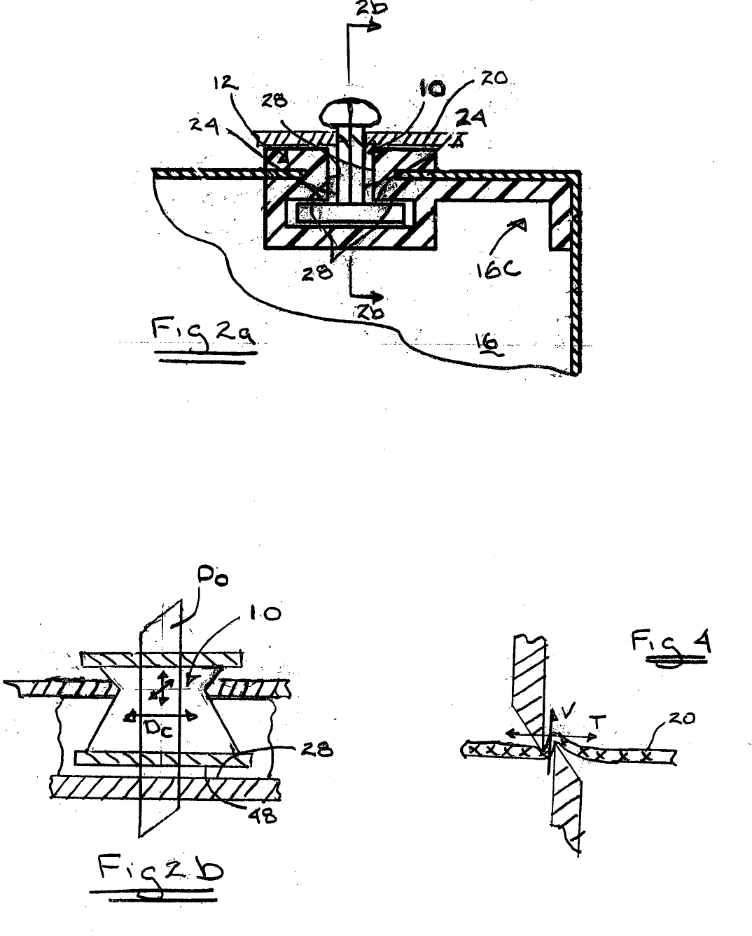

In FIG. 2a the shearing device 10 and guide 12 are recessed relative to the external profile of the container 16 so as to effect a low profile cross-sectional geometry. Further, the shearing device 10 and guide 12 are preferably disposed proximal to a corner 12C of the container 12 such that the recessed cutting assembly 14 does not interfere or bind with the webbed material 20.

Before describing the specific geometry and/or structural elements of the shearing device 10, it will be useful to generally discuss the function and interaction of the shearing device 10 with other cutting assembly or dispenser components. In FIGS. 2a and 2b, the shearing device 10 is adapted for traversing relative to the guide 12 in a desired cutting direction. Specifically, the shearing device 10 defines one or more bearing surfaces 24 which are adapted to engage one or more guide surfaces 28 within the elongate guide 12. Functionally, the bearing and guide surfaces 24, 28 cooperate to permit sliding motion therebetween in the cutting direction (shown as an arrow D_{C} in FIG. 2b) and interlock to delimit motion of the shearing device 10 relative to the guide 12 in directions orthogonal to the cutting direction (shown as an plane D_{O} in FIG. 2b). With respect to the latter, the surfaces 24, 28 interact to prevent the shearing device 10 from moving vertically or horizontally relative to the guide 12 or from rotating about an axis parallel to the cutting direction D_{C}. Furthermore, the shearing device 10 is adapted for traversing in either direction within the elongate guide 12 and, therefore, may be adapted to cut in either or both directions.

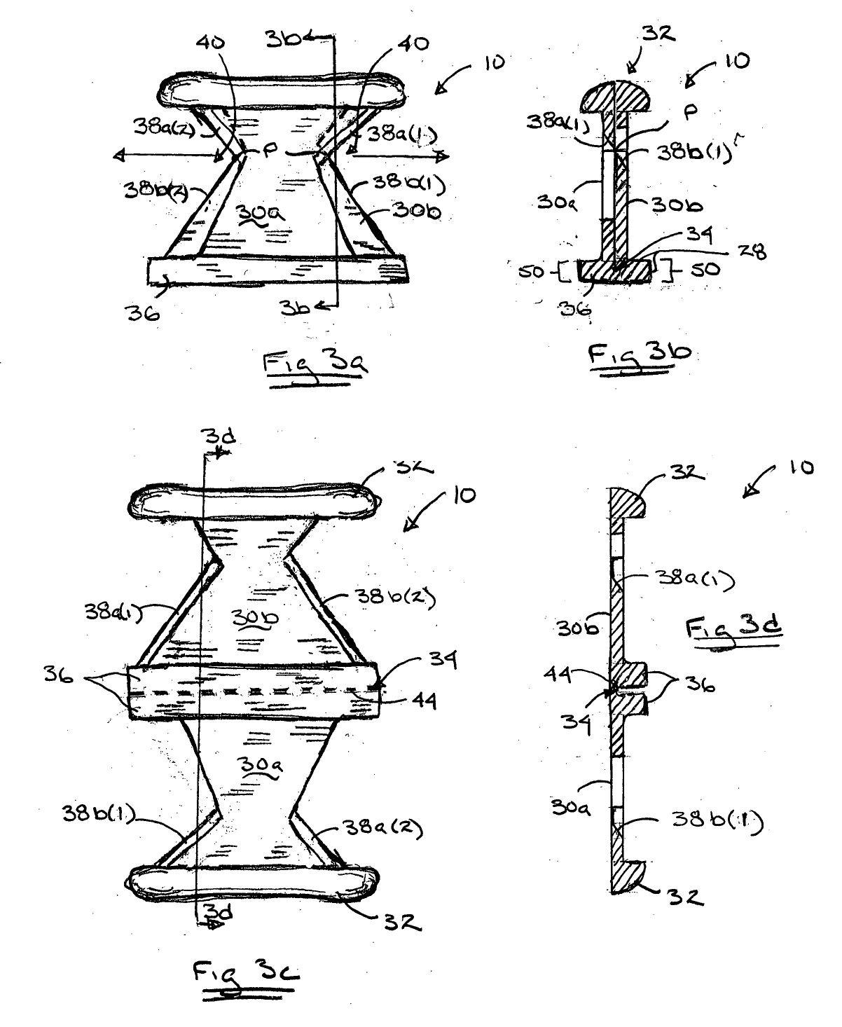

Referring now to FIGS. 3a-3d, the shearing device 10 comprises a pair of juxtaposed cutting blades 30a, 30b, a handle 32 disposed in combination with one or more of the blades 30a, 30b, a connecting means 34 for maintaining the relative spatial position of the cutting blades 30a, 30b, and a bearing support structure 36 protruding laterally from one or both of the cutting blades 30a, 30b. In the preferred embodiment, the cutting blades 30a, 30b define edge portions 38a(1), 38b(1) which are inclined relative to the cutting direction D_{C}. Further, the cutting blades 30a, 30b are disposed in juxtaposed relation such that the inclined cutting edge portions 38a(1), 38b(1) spatially converge to define a throat 40 and a convergence point P. As such, as the web material (not shown in FIGS. 3a-3d) is introduced into the throat 40, the converging edges 38a(1), 38b(1) direct the material to the convergence point P.

In the described embodiment, the cutting edge portions 38a(1), 38b(1) define a substantially V-shaped geometric profile wherein the convengence point P is the vertex of two intersecting lines i.e., defined by each of the inclined cutting edges 38a(1), 38b(1). In the context used herein, substantially V-shaped means any two cutting edges which converge at a point and define a throat characterized by decreased edge spacing, (transverse to the cutting direction), as the web material 20 is introduced to the cutting blades 30a, 30b. It should be understood however, that the cutting edges 38a(1), 38b(1) may have a different geometric shape, e.g., two substantially convex or concave-shaped cutting edges defining a cycloid, while still meeting definition of a V-shaped geometric profile.

In the red embodiment, both of the cutting edges 38a(1), 38b(1) are sharpened, however, a single cutting edge 38a(1) or 38b(1) may be employed to reduce processing steps and/or manufacturing costs. That is, the cutting edges 38a(1), 38b(1) will still perform their intended function with only a single sharpened edge. Furthermore, the cutting edges 38a(1), 38b(1), 38a(2), 38b(2) are preferably formed on both sides of the cutting blades 30a, 30b i.e., along oppositely disposed ends of the blade to facilitate bi-directional cutting operations.

The connecting means 34 maintains the spatial relationship of the cutting blades during cutting operations, i.e., either in one or both cutting directions D_{C}, but may include any of a variety of connecting methods or devices. In the preferred embodiment, the connecting means is a hinge 44 integrally formed along an edge of the cutting blades 30a, 30b. As such, the shearing device 10 may be formed, manufactured or molded as a unit and folded about the hinge 44 to juxtaposition the cutting blades 30a, 30b. In the described embodiment, an effective hinge 44 is produced by reducing the material thickness at a point along the lower edges of the cutting blades 30a, 30b. Alternatively, a mechanical interlock assembly (not shown) may be employed having a male member integrally formed and protruding from a side of one of the cutting blades, and a female member having an orifice integrally formed within a side of the other of the cutting blades for accepting the male member. The teachings described herein are readily implementable to those skilled in the art and it will be appreciated that a variety of other connecting means can be envisioned.

While the cutting blades 30a, 30b may be composed of a variety of material compositions, it is preferable to compose the shearing device from a formable polymer, e.g., a thermoplastic or other plastic material. As such, the cutting blades 30a, 30b may be fabricated by a low cost injection molding process. The embodiment which includes the hinged connecting means 34, i.e., wherein the shearing device 10 is a singular unit, is particularly well suited to such molding process.

The bearing support member 36 is preferably configured in the shape of a rectangular key 50 upon which is formed the bearing surfaces 28 of the shearing device 10. The key 50 is adapted for slideably engaging a similarly shaped guide surface 24 of the cutting assembly 14. Moreover, in the preferred embodiment, a key 50 is disposed on each of the cutting blades 30a, 30b and defines a substantially T-shaped cross sectional configuration. The guide 12, therefore, also has a complimentary T-shaped cross section.

To improve the profile geometry of the shearing device 10 yet further and prior to use, it may be desirable to incorporate design features which facilitate assembly/disassembly of the shearing device 10 relative to the guide 12. That is, to facilitate packaging/shipping/store display, the guide 12 may be integrated with the container 16 as described and illustrated herein (i.e., recessed and proximal to a corner of the container), however, the shearing device 10 may be provided as a separate component for subsequent assembly/installation. Regarding the latter, an aperture or enlarged opening (not shown) is provided in the guide 12 to facilitate receipt and installation of the shearing device 10 within the guide 12. Alternatively, the guide and bearing surfaces 24, 28 may be resilient to permit a small degree of flexure, thereby enabling the guide surfaces 28 to move apart when introducing the shearing device 10 into the guide 12.

In operation, and referring collectively to FIGS. 1-3d, the shearing device 10 is positioned at an extreme end of the guide 12 (best shown in FIG. 1) so as to permit unobstructed placement of the material 20 across the guide 12 The material 20 may secured along the exterior surface of the guide 12 by means of temporary adhesive strips (not shown) disposed on either or both sides of the guide 12. The shearing device 10 is then caused to traverse within the guide 12 to effect an edgewise cut through/across the width of the material 20. As discussed previously, the shearing device 10 may employ cutting edges 38a(1), 38b(1), 38a(2), 38b(2) (FIG. 3b) along opposing edges such that the shearing device 10 may operate in either direction. Furthermore, the height dimension of the shearing device 10 relative to the guide 12, i.e., the portion of the blade 30a, 30b projecting above the guide 12 need only be slightly larger than the thickness dimension of the material selected to be cut. Consequently, the profile of the shearing device 10 can be minimized and safety maximized by employing a blades 30a, 30b based upon these design criteria.

In FIG. 4, the shearing device 10 traverses in the guide to make an edgewise cut through the web material 20. The converging blades 30a, 30b function to apply a combination of shear and tensile loads, V and T, respectively, to the web material. By comparison, a single edge blade of the prior art principally applies only tensile loads to cut material. As a consequence, the shearing 10 produces a clean, reliable cut through the material without the requirement for highly sharpened blades.

While the invention is described in the context of a guided cutting assembly used in combination with a conventional elongate cardboard container, it should be understood that the inventive shearing device may be employed with any guided cutting assembly, or any dispenser, which may or may not dispense sheet material which has been rolled. Further, while the shearing device has particular application in small containers typically used to dispense household products such as plastic wraps, foils or paper, the shearing device has utility in more sophisticated commercial/industrial applications, for example for cutting a web of material in a manufacturing environment. The illustrated embodiments described herein depict the shearing device assembled in combination with a dispensing container. It should be understood, however, that the inventive shearing device may be provided as an independent element and installed/assembled with the guide or container subsequent to sale or delivery.

In summary, the structural and functional elements described herein provide the teachings necessary to design and fabricate a shearing device for use in cutting assemblies. The shearing device facilitates manufacture using low cost fabrication methods, e.g., injection molding of thermoplastic or other polymeric materials. Furthermore, the shearing action of the blades provides clean reliable cut without the requirement or need for highly sharpened edges. Additionally, product safety is improved. Finally, the shearing device provides a simple, pragmatic, low cost alternative to the cutting devices of the prior art.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A shearing device adapted for use within a cutting assembly operative to guide the shearing device in a desired cutting direction, the shearing device comprising:
at least one pair of cutting blades, each cutting blade defining a at least one sharpened edge inclined relative to the cutting direction, said blades being juxtaposed such that the inclined edges spatially converge to define a throat region and a convergence point;
connecting means for maintaining the relative spatial position of the cutting blades;
at least one bearing support structure disposed in combination with at least one of the cutting blades, the bearing support structure adapted for engaging a guide of the cutting assembly; and
a handle disposed in combination with at least one of the cutting blades and adapted for traversing the cutting blades in the cutting assembly guide.

2. The shearing device according to claim 1 wherein the throat region and convergence point define a substantially V-shaped profile configuration.

3. The shearing device according to claim 1 wherein both of the converging edges are sharpened.

4. The shearing device according to claim 1 wherein each cutting blade defines inclined edges along oppositely disposed ends of the blade to facilitate bi-directional cutting operations.

5. The shearing device according to claim 1 wherein the connecting means is a hinge integrally formed along an edge of each cutting blade.

6. The shearing device according to claim 1 wherein the connecting means is a mechanical interlock assembly between the cutting blades, the interlock assembly including a male member integrally formed and protruding from a side of one of the cutting blades, and a female member having an orifice integrally formed within a side of the other of the cutting blades for accepting the male member.

7. The shearing device according to claim 1 wherein the cutting blades are composed of a formable polymer material.

8. The shearing device according to claim 5 wherein the cutting blades and integral hinge are composed of a formable polymer material and are fabricated by injection molding.

9. The shearing device according to claim 1 wherein the bearing support member defines at least one key adapted for engaging an elongate keyway of the cutting assembly.

10. The shearing device according to claim 9 wherein a key is disposed on each of the cutting blades and defines a substantially T-shaped cross sectional configuration.

11. A cutting assembly for use in combination with a container for dispensing a web of material, the cutting assembly comprising:
a guide disposed in combination with a sidewall of the container, and defining at least one guide surface; and
a shearing device adapted for traversing within said elongate guide in a desired cutting direction, and defining at least one bearing surface,
said guide and bearing surfaces cooperating to permit sliding motion therebetween in said cutting direction and interlocking to delimit motion of said shearing device relative to said guide in directions orthogonal to said cutting direction,
said shearing device further including
at least one pair of cutting blades, each cutting blade defining at least one sharpened edge inclined relative to the cutting direction, said blades being juxtaposed such that the inclined edges spatially converge to define a throat region and a convergence point;
connecting means for maintaining the relative spatial position of the cutting blades;
at least one bearing support structure disposed in combination with at least one of the cutting blades, the bearing support structure adapted for engaging a guide of the cutting assembly; and
a handle disposed in combination with at least one of the cutting blades and adapted for traversing the cutting blades in the cutting assembly guide.

12. The cutting assembly device according to claim 11 wherein the throat region and convergence point of said shearing device define a substantially V-shaped profile configuration.

13. The cutting assembly according to claim 11 wherein both of the converging edges of said shearing device are sharpened.

14. The cutting assembly according to claim 11 wherein each cutting blade of said shearing device defines inclined edges along oppositely disposed ends of the blade to facilitate bi-directional cutting operations.

15. The cutting assembly according to claim 11 wherein the connecting means of said shearing device is a hinge integrally formed along an edge of each cutting blade.

16. The cutting assembly according to claim 11 wherein the connecting means of said shearing device is a mechanical interlock assembly between the cutting blades, the interlock assembly including a male member integrally formed and protruding from a side of one of the cutting blades, and a female member having an orifice integrally formed within a side of the other of the cutting blades for accepting the male member.

17. The cutting assembly according to claim 11 wherein the cutting blades of said shearing device are composed of a formable polymer material.

18. The cutting assembly according to claim 15 wherein the cutting blades and integral hinge of said shearing device are composed of a formable polymer material and are fabricated by injection molding.

19. The cutting assembly according to claim 11 wherein the bearing support member of said shearing device defines at least one key adapted for engaging an elongate keyway of the cutting assembly.

20. The cutting assembly according to claim 19 wherein said key is disposed on each of the cutting blades and defines a substantially T-shaped cross sectional configuration.
